(19) United States
(12) Patent Application Publication
(10) Pub. No.: US 2003/0013420 A1
(43) Pub. Date: Jan. 16, 2003

(54) Communication device for pets and pet owners

(76) Inventor: Michael Redmond, Brooklyn, NY (US)

Correspondence Address: Richard W. Goldstein, 2071 Clove Road, Staten Island, NY, 10304, US

(21) Appl. No.: 09/901,755

(22) Filed: Jul. 10, 2001

(51) Int. Cl. H04B 1/034

(52) U.S. Cl. 455/100; 455/39

(57) ABSTRACT

A communication device for pets and pet owners including a collar adapted for be positioned around a neck of a domesticated animal. A first communicator is coupled with the collar. The first communicator is equipped with a speaker and a two-way open microphone. A second communicator is adapted for being held by a pet owner. The second communicator is in communication with the first communicator. The second communicator consists of a housing. The housing includes a speaker/microphone disposed in a front face thereof. The speaker/microphone includes a first control button and a second control button. The first control button allows the pet owner to speak to the animal through the speaker of the first communicator. The second control button allows the pet owner to listen to the animal through the two-way open microphone.

### BACKGROUND OF THE INVENTION

The present invention relates to a communication device for pets and pet owners and more particularly pertains to allowing a pet owner to speak to and hear their pet.

The use of electronic monitoring and communicating devices is known in the prior art. More specifically, electronic monitoring and communicating devices heretofore devised and utilized for the purpose of facilitating communication are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,967,696 to Tobias discloses a dog collar with a receiver unit incorporated and appears capable of emitting a sound, such as a human voice, sent from a conventional transmitter for communicating with the animal. U.S. Pat. No. 4,598,272 to Cox discloses means for monitoring a person or pet using pairs of transmitters and receivers allowing for two way communications. U.S. Pat. No. 5,119,072 to Hemingway discloses means for monitoring children using a microphone and transmitter device.

While these devices fulfill their respective, particular objective and requirements, the aforementioned patents do not describe a communication device for pets and pet owners for allowing a pet owner to speak to and hear their pet.

In this respect, the communication device for pets and pet owners according to the present invention substantially departs from the conventional concepts and designs of the prior art, and in doing so provides an apparatus primarily developed for the purpose of allowing a pet owner to speak to and hear their pet.

Therefore, it can be appreciated that there exists a continuing need for a new and improved communication device for pets and pet owners which can be used for allowing a pet owner to speak to and hear their pet. In this regard, the present invention substantially fulfills this need.

### SUMMARY OF THE INVENTION

In the view of the foregoing disadvantages inherent in the known types of electronic monitoring and communicating devices now present in the prior art, the present invention provides an improved communication device for pets and pet owners. As such, the general purpose of the present invention, which will be described subsequently in greater detail, is to provide a new and improved communication device for pets and pet owners which has all the advantages of the prior art and none of the disadvantages.

To attain this, the present invention essentially comprises a collar adapted for be positioned around a neck of a domesticated animal. A first communicator is coupled with the collar. The first communicator is equipped with a speaker and a two-way open microphone. A second communicator is adapted for being held by a pet owner. The second communicator is in communication with the first communicator. The second communicator consists of a housing. The housing includes a speaker/microphone disposed in a front face thereof. The speaker/microphone includes a first control button and a second control button. The first control button allows the pet owner to speak to the animal through the speaker of the first communicator. The second control button allows the pet owner to listen to the animal through the two-way open microphone.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved communication device for pets and pet owners which has all the advantages of the prior art electronic monitoring and communicating devices and none of the disadvantages.

It is another object of the present invention to provide a new and improved communication device for pets and pet owners which may be easily and efficiently manufactured and marketed.

It is a further object of the present invention to provide a new and improved communication device for pets and pet owners which is of durable and reliable construction.

An even further object of the present invention is to provide a new and improved communication device for pets and pet owners which is susceptible of a low cost of manufacture with regard to both materials and labor, and which accordingly is then susceptible of low prices of sale to the consuming public, thereby making such a communication device for pets and pet owners economically available to the buying public.

Even still another object of the present invention is to provide a new and improved communication device for pets and pet owners for allowing a pet owner to speak to and hear their pet.

Lastly, it is an object of the present invention to provide a new and improved communication device for pets and pet owners including a collar adapted for be positioned around a neck of a domesticated animal. A first communicator is coupled with the collar. The first communicator is equipped with a speaker and a two-way open microphone. A second communicator is adapted for being held by a pet owner. The second communicator is in communication with the first communicator. The second communicator consists of a housing. The housing includes a speaker/microphone disposed in a front face thereof. The speaker/microphone includes a first control button and a second control button. The first control button allows the pet owner to speak to the animal through the speaker of the first communicator. The second control button allows the pet owner to listen to the animal through the two-way open microphone.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the communication device for pets and pet owners constructed in accordance with the principles of the present invention.

FIG. 2 is a front view of the receiver of the present invention.

FIG. 3 is a perspective view of the present invention illustrated in use.

The same reference numerals refer to the same parts through the various figures.

### DESCRIPTION OF THE PREFERRED EMBODIMENT

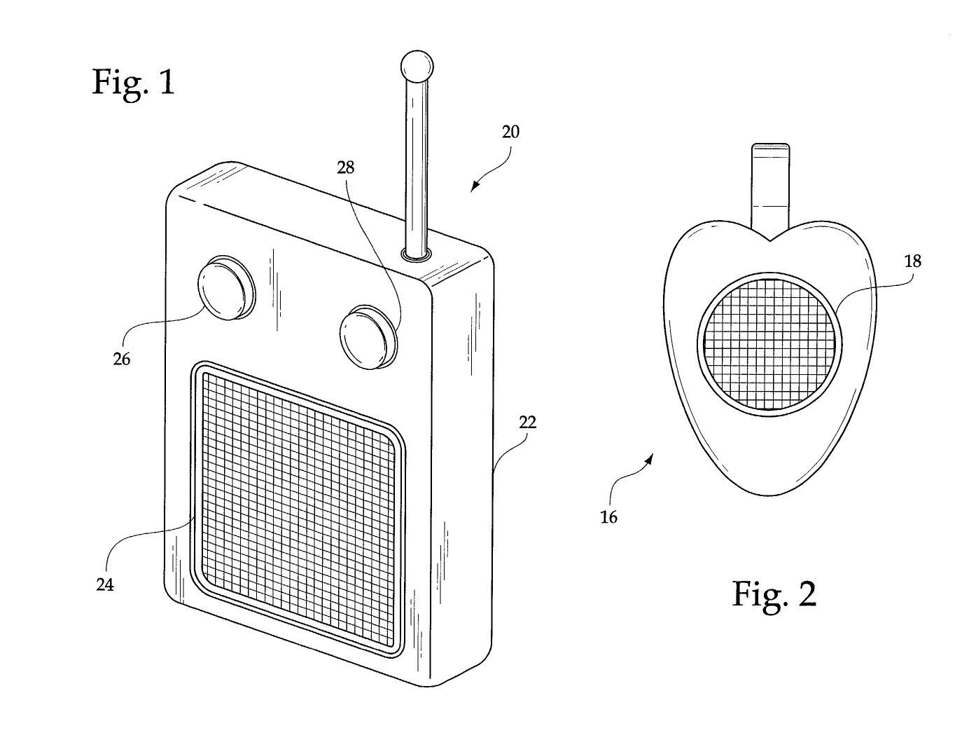

With reference now to the drawings, and in particular, to FIGS. 1 through three thereof, the preferred embodiment of the new and improved communication device for pets and pet owners embodying the principles and concepts of the present invention and generally designated by the reference number 10 will be described.

Specifically, it will be noted in the various Figures that the device relates to a communication device for pets and pet owners for allowing a pet owner to speak to and hear their pet. In its broadest context, the device consists of a collar, a first communicator, and a second communicator. Such components are individually configured and correlated with respect to each other so as to attain the desired objective.

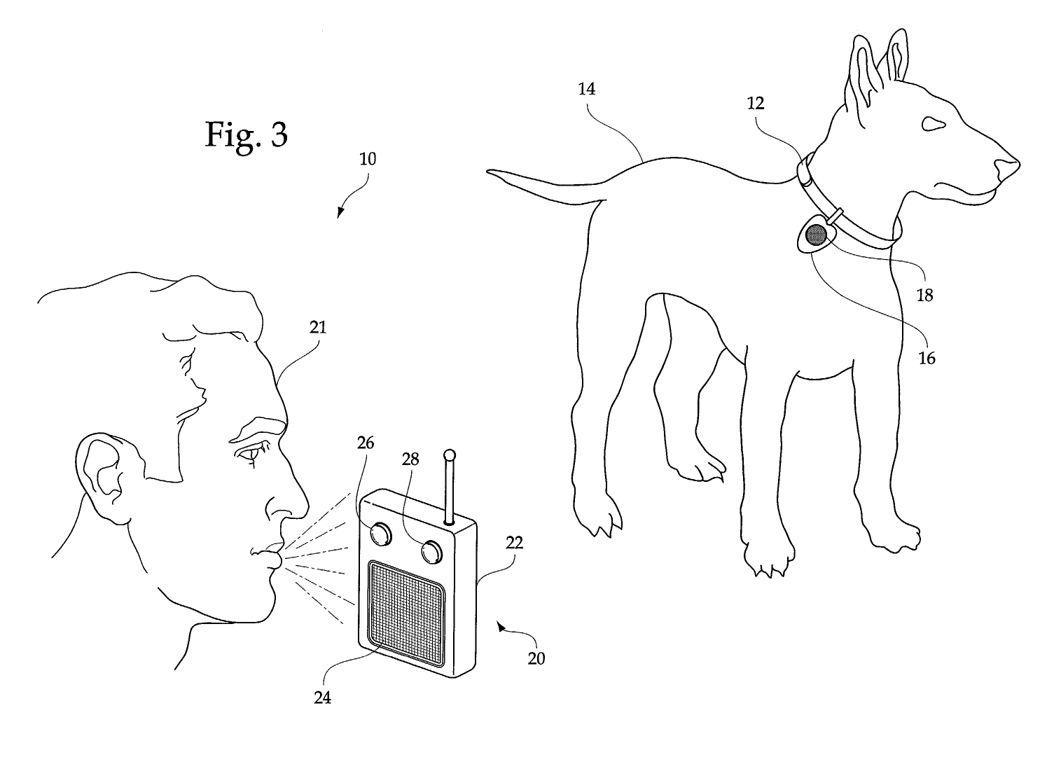

The collar 12 is adapted for be positioned around a neck of a domesticated animal 14. Note FIG. 3. The collar 12 will be similar in structure to typical collars known in the art.

The first communicator 16 is coupled with the collar 12. The first communicator 16 is equipped with a speaker and a two-way open microphone 18. The speaker and two-way open microphone 18 are shown in combination as a single element. The first communicator 16 will be designed to resemble a pendant or other adornments that typically are found attached to standard animal collars. Note FIG. 2.

The second communicator 20 is adapted for being held by a pet owner 21. Note figures one and three. The second communicator 20 is in communication with the first communicator 16. The second communicator 20 consists of a housing 22. The housing 22 includes a speaker/microphone 24 disposed in a front face thereof. The speaker/microphone 24 includes a first control button 26 and a second control button 28. The first control button 26 allows the pet owner 21 to speak to the animal 14 through the speaker 18 of the first communicator 12. The second control button 28 allows the pet owner 21 to listen to the animal 14 through the two-way open microphone 18.

In use, the pet owner 21 can press the first control button 26 in order to allow the animal 14 to hear his/her voice. The pet owner 21 can press the second control button 28 in order to hear any sounds made by the animal 14.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A communication device for pets and pet owners for allowing a pet owner to speak to and hear their pet comprising, in combination:
a collar adapted for be positioned around a neck of a domesticated animal;
a first communicator coupled with the collar, the first communicator being equipped with a speaker and a two-way open microphone;
a second communicator adapted for being held by a pet owner, the second communicator being in communication with the first communicator, the second communicator being comprised of a housing, the housing including a speaker/microphone disposed in a front face thereof, the speaker/microphone including a first control button and a second control button, the first control button allowing the pet owner to speak to the animal through the speaker of the first communicator, the second control button allowing the pet owner to listen to the animal through the two-way open microphone.
